(19) United States
(12) Patent Application Publication
(10) Pub. No.: US 2026/0210146 A1
(43) Pub. Date: Jul. 23, 2026

(54) Digital Memorial System with Conversational Artificial Intelligence for Permanent Grave Site Installation

(71) Applicant: Nathan Byron, Deland, FL (US)

(72) Inventor: Nathan Byron, Deland, FL (US)

(21) Appl. No.: 19/562,097

(22) Filed: Mar. 10, 2026

Related U.S. Application Data
(60) Provisional application No. 63/783,964, filed on Apr. 5, 2025.

(51) Int. Cl. E04H 13/00; G10L 15/18; G10L 15/22

(52) U.S. Cl. CPC E04H 13/001; G10L 15/1815; G10L 15/22; G10L 2015/225

(57) ABSTRACT

A digital memorial system configured for permanent outdoor installation at a grave site includes a weather-resistant housing, a display, a touchscreen interface, a microphone, a processor, and memory storing biographical data associated with a deceased individual. A conversational artificial intelligence engine generates dynamic, context-responsive outputs representing the deceased individual based on stored data and user input. The system enables interactive conversational engagement at the physical memorial location. In certain embodiments, the system communicates with a remote server to enable cloud-based conversational processing and remote access by additional users.

### CROSS-REFERENCE TO RELATED APPLICATIONS

This application claims priority to U.S. Provisional Patent Application No. 63/783,964, filed Apr. 5, 2025, the contents of which are incorporated herein by reference in their entirety.

### STATEMENT REGARDING FEDERALLY SPONSORED RESEARCH

Not applicable.

### FIELD OF THE INVENTION

The present invention relates to digital memorial systems and, more particularly, to permanently installed outdoor memorial devices configured to generate interactive conversational representations of deceased individuals using artificial intelligence.

### BACKGROUND OF THE INVENTION

Traditional grave markers provide static inscriptions that do not allow interactive engagement.

Online memorial platforms provide remote memorial content but do not integrate permanently installed outdoor memorial devices capable of dynamic conversational interaction at a physical grave site.

Existing memorial systems that provide audio or video playback rely on prerecorded content and do not enable real-time, context-responsive conversational interaction based on user input.

There exists a need for a durable outdoor digital memorial system capable of generating real-time conversational interaction representing a deceased individual while permanently installed at a memorial location.

### SUMMARY OF THE INVENTION

The invention provides a digital memorial system configured for permanent outdoor installation at a grave site.

The system includes a weather-resistant housing, a display, a touchscreen interface, a microphone, a processor, and memory storing biographical data associated with a deceased individual.

A conversational artificial intelligence engine generates dynamic, context-responsive responses to user input, enabling interactive engagement at the physical memorial location.

In certain embodiments, conversational processing may be executed locally or via a remote server.

Additional embodiments may include remote user access, unique device identifiers, authorization controls, centralized management systems, and network-based data updates.

### BRIEF DESCRIPTION OF THE DRAWINGS

FIG. 1 illustrates a front perspective view of a digital memorial device permanently installed at a grave site.

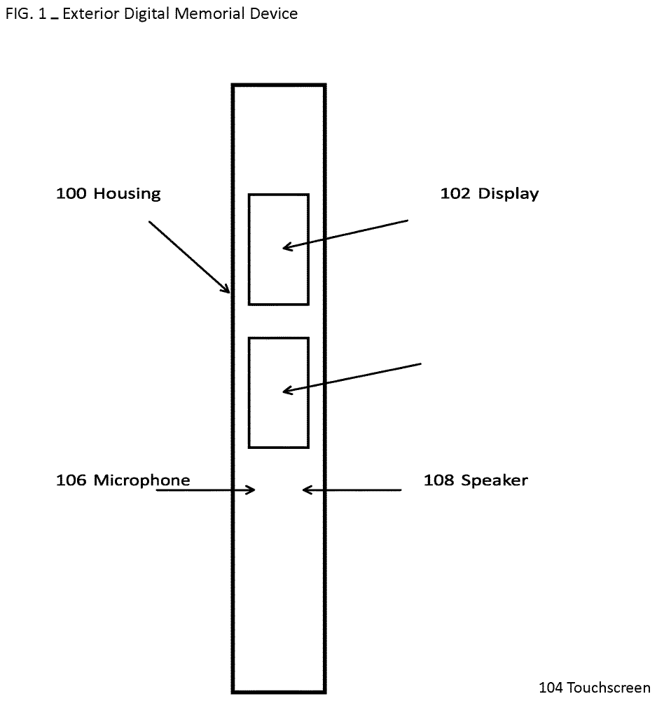

FIG. 2 illustrates a block diagram of internal components of the digital memorial system.

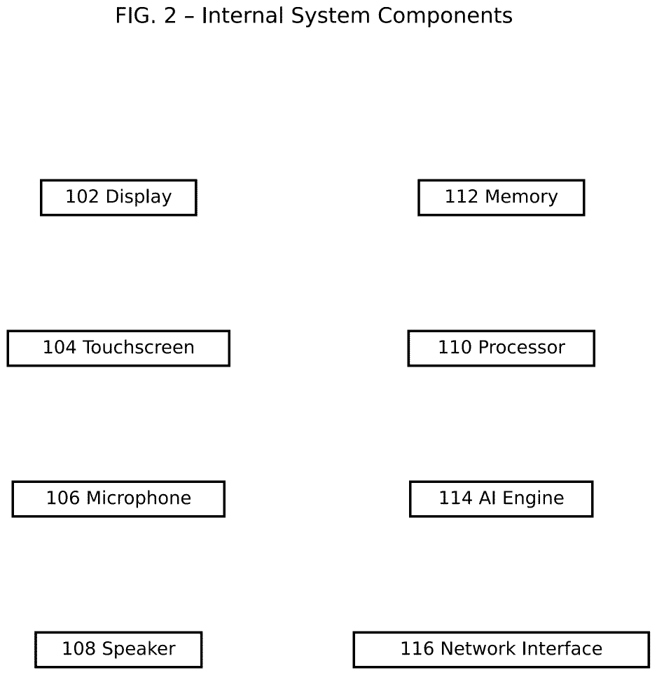

FIG. 3 illustrates a system diagram showing communication between the memorial device and a remote server.

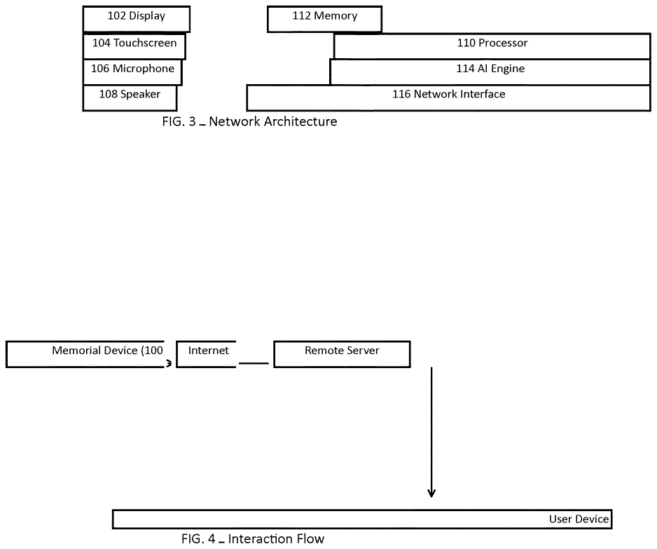

FIG. 4 illustrates a flow diagram of conversational interaction processing.

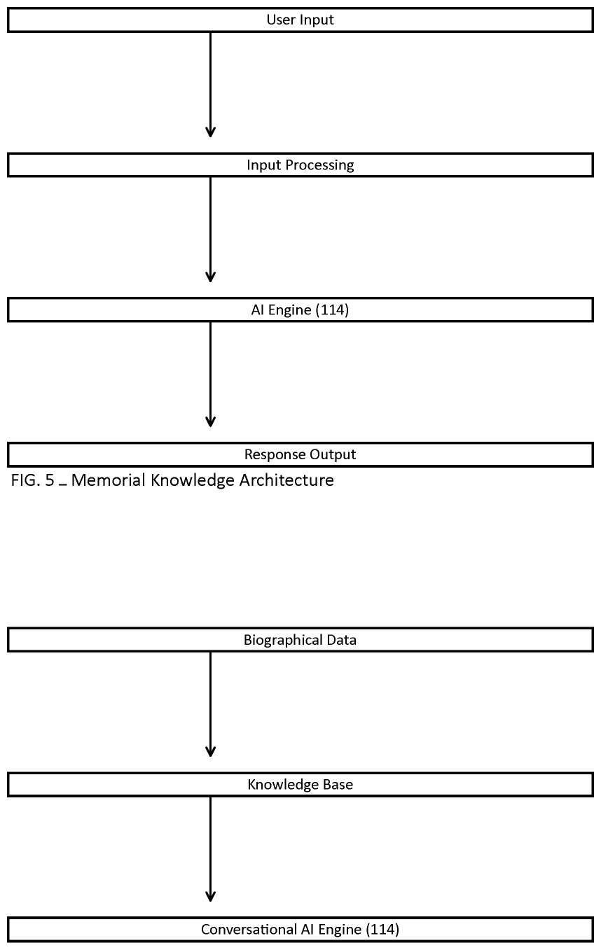

FIG. 5 illustrates a knowledge architecture for conversational Al.

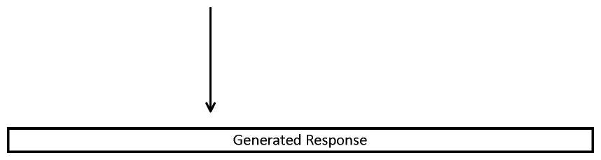

### DETAILED DESCRIPTION OF THE INVENTION

### Physical Structure

In one embodiment, the digital memorial system includes a weather-resistant housing configured for permanent installation at a grave site.

The housing may be constructed from metal, stone, composite material, or other durable outdoor-rated materials.

The housing may be mounted directly to a headstone, integrated into a monument structure, or installed as a freestanding memorial device adjacent to a grave marker.

The housing includes a display panel, touchscreen interface, microphone, speaker, processor, and memory.

The display may be sunlight-readable and sealed to prevent moisture intrusion.

### Power Supply Embodiments

The system may be powered by a wired electrical connection, a rechargeable battery, a solar power system, or any combination thereof.

In certain embodiments, solar panels may be integrated into the memorial structure.

### Conversational Artificial Intelligence Engine

The processor executes a conversational artificial intelligence engine configured to generate dynamic outputs representing a deceased individual.

The memory stores biographical and contextual data associated with the deceased individual.

In certain embodiments, the Al engine generates responses dynamically in real time.

### User Interaction

A user may interact with the memorial system by touch input or spoken input.

Generated responses may be displayed as text or synthesized speech.

### Remote Access Embodiment

In certain embodiments, the system includes a network interface configured to communicate with a remote server.

### Identity and Authorization Embodiments

The system may include assignment of a unique digital identifier.

### Alternative Embodiments

The system may be installed at cemeteries, mausoleums, memorial parks, or other locations.

1. A digital memorial system comprising:
a weather-resistant housing configured for permanent outdoor installation at a grave site;
a display disposed within the housing;
an input interface configured to receive user input;
a microphone configured to receive audio input from a user;
a processor; and
a memory storing biographical data associated with a deceased individual;
wherein the processor executes a conversational artificial intelligence engine configured to generate dynamic, context-responsive conversational outputs representing the deceased individual based on the biographical data and user input; and wherein the conversational outputsare presented as visual output on the display and as synthesized speech through an audio speaker
integrated within the housing.

2. The digital memorial system of claim 1, further comprising a network interface configured to communicate with a remote server.

3. The digital memorial system of claim 2, wherein the conversational artificial intelligence engine is executed at least partially on the remote server.

4. The digital memorial system of claim 1, wherein the housing is sealed to withstand outdoor environmental exposure.

5. The digital memorial system of claim 1, further comprising an audio speaker configured to output synthesized speech corresponding to the conversational outputs.

6. The digital memorial system of claim 1, wherein the memory further stores voice pattern data associated with the deceased individual.

7. The digital memorial system of claim 1, wherein the conversational artificial intelligence engine utilizes natural language processing to interpret user input.

8. The digital memorial system of claim 1, wherein the system is powered by at least one of a wired electrical connection, a rechargeable battery, or a solar power source.

9. The digital memorial system of claim 1, wherein the device is mounted to a headstone or grave marker.

10. The digital memorial system of claim 1, wherein user input includes spoken questions captured by the microphone.

11. The digital memorial system of claim 1, further comprising a unique digital identifier stored in memory and associated with the memorial device.

12. The digital memorial system of claim 11, wherein activation of conversational interaction requires validation of the unique digital identifier.

13. A method of providing posthumous conversational interaction at a physical grave site, comprising:
installing a digital memorial device at the grave site;
storing biographical data associated with a deceased individual;
receiving user input through at least one of a touchscreen and a microphone;
processing the user input using a conversational artificial intelligence engine to generate a dynamic response representing the deceased individual; and
presenting the dynamic response through a display integrated into the memorial device.

14. The method of claim 13, further comprising transmitting user input to a remote server for processing.

15. The method of claim 13, wherein the generated response is dynamically created in real time and is not a prerecorded playback.

16. The digital memorial system of claim 1, wherein the system further comprises a centralized management platform configured to register and administer a plurality of digital memorial devices, each digital memorial device being associated with a unique memorial identity identifier used to authenticate and enable conversational interaction representing a deceased individual.
